(19) United States
(12) Patent Application Publication
(10) Pub. No.: US 2009/0217982 A1
(43) Pub. Date: Sep. 3, 2009

(54) ADJUSTABLE FLOW CONTROLLERS FOR REAL-TIME MODULATION OF FLOW RATE

(75) Inventor: Paul Mario DiPerna, San Clemente, CA (US)

Correspondence Address: Luce, Forward, Hamilton & Scripps LLP, 2050 Main Street, Suite 600, Irvine, CA, 92614, US

(73) Assignee: PHLUID INC.

(21) Appl. No.: 12/039,693

(22) Filed: Feb. 28, 2008

(51) Int. Cl. G05D 7/06; F17D 1/14; F16K 31/00

(52) U.S. Cl. 137/8; 137/486; 137/487.5

(57) ABSTRACT

Clamps to be used in conjunction with real-time or nearly real-time measurement of the flow rate of a fluid through a lumen. The clamps allow for more precise control over the volume of fluid delivered and over the flow rate. When the flow rate is determined to be too fast, the clamps are expanded, which slow down the flow rate. Conversely, when the flow rate is determined to be too slow, the clamps are returned to an unexpanded state, which increases the flow rate. Additionally, if an error state is observed, the clamps are designed to arrest flow, thereby preventing further delivery of fluid.

### BACKGROUND

This disclosure relates to flow regulators designed to ensure substantially constant flow rate through a conduit, tube, or pipe, etc.

### SUMMARY

Clamps to be used in conjunction with real-time or about real-time measurement of the flow rate of a fluid through a lumen. The clamps allow for more precise control over the flow rate and therefore over the volume of fluid. When the flow rate is determined to be too fast, the clamps are expanded, which slow down the flow rate. Conversely, when the flow rate is determined to be too slow, the clamps are contracted, which increases the flow rate. Additionally, if an error state is observed, the clamps may arrest flow, thereby preventing further delivery of fluid.

According to a feature of the present disclosure, a device is disclosed comprising a vessel for transporting a fluid, an expandable member disposed with the vessel for transporting the fluid, a pressure controller for modulating the pressure within the expandable member, and a microprocessor for calculating a calculated flow rate. The pressure in the pressure in the expandable member is modulated to control the flow rate of the fluid through the vessel. Moreover, the modulation is determined at least based on data provided from the calculated flow rate.

According to a feature of the present disclosure, a method is disclosed comprising providing a vessel for transporting a fluid, an expandable member disposed with the vessel for transporting the fluid, a pressure controller for modulating the pressure within the expandable member; and a microprocessor for calculating a flow rate of the fluid. The pressure in the expandable member is modulated to control the flow rate of the fluid through the vessel and the modulation is determined at least based on data provided from the calculated flow rate.

According to a feature of the present disclosure, a method is disclosed comprising measuring the flow rate of a fluid within a vessel for transporting the fluid in about real time and modulating the expansion of an expandable member disposed with the vessel for transporting the fluid to change to flow rate of the fluid through the vessel based at least in part on the measured flow rate.

### DRAWINGS

The above-mentioned features and objects of the present disclosure will become more apparent with reference to the following description taken in conjunction with the accompanying drawings wherein like reference numerals denote like elements and in which:

FIG. 1 is side sectional view of embodiments of the devices of the present disclosure disposed within a vessel connected to a pressure controller;

FIG. 2A is a side sectional view of embodiments of the devices of the present disclosure introduced into a lumen through an auxiliary lumen;

FIG. 2B is a side sectional view of embodiments of the devices of the present disclosure introduced into a lumen from an auxiliary lumen where an expandable member is build directly into the auxiliary lumen;

FIG. 2C is a side sectional view of an embodiment of the device of FIG. 2B illustrating expansion of an expandable member to prevent flow through the lumen;

FIGS. 3A and 3B are top sectional views of an embodiment of the device of FIG. 1 disposed within a vessel in an unexpanded state (FIG. 3A) and an expanded state (FIG. 3B);

FIG. 4 is a side sectional view of an embodiments of a clamp of the present disclosure disposed around a lumen whereby expansion of the clamp causes the lumen to compress against a block thereby restricting flow;

FIG. 5A through 5C are graphs of embodiments of theoretical and actual flow volume of a finite fluid source over time in which the balloon clamp is in operation; and

FIG. 6 is a flow diagram of embodiments of use of balloon clamps in a system measuring about real time flow rates of fluids flowing through a lumen.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, biological, electrical, functional, and other changes may be made without departing from the scope of the present invention. The following detailed description is, therefore, not to be taken in a limiting sense, and the scope of the present invention is defined only by the appended claims. As used in the present disclosure, the term “or” shall be understood to be defined as a logical disjunction and shall not indicate an exclusive disjunction unless expressly indicated as such or notated as “xor.”

As used in the present disclosure, the term “real time” shall be defined as real time or lagging real time only by the time taken to compute a measurement, provided the measurement computed reasonably approximates the state of at the beginning of the measurement process and at the end of the measurement process.

As used in the present disclosure, the term “expansion” shall be defined as the ability of the expandable members of the present disclosure to increase or decrease in volume.

As used in the present disclosure, the term “contract” shall be defined as the decrease in volume of the expandable members of the present disclosure.

As used in the present disclosure, the term “modulate” shall be defined as changing the volume of an expandable member to effect a change in volume of the expandable member to a desired, determined, calculated, or predetermined volume. “Modulate” encompasses both increases in volume as well as decreases in volume.

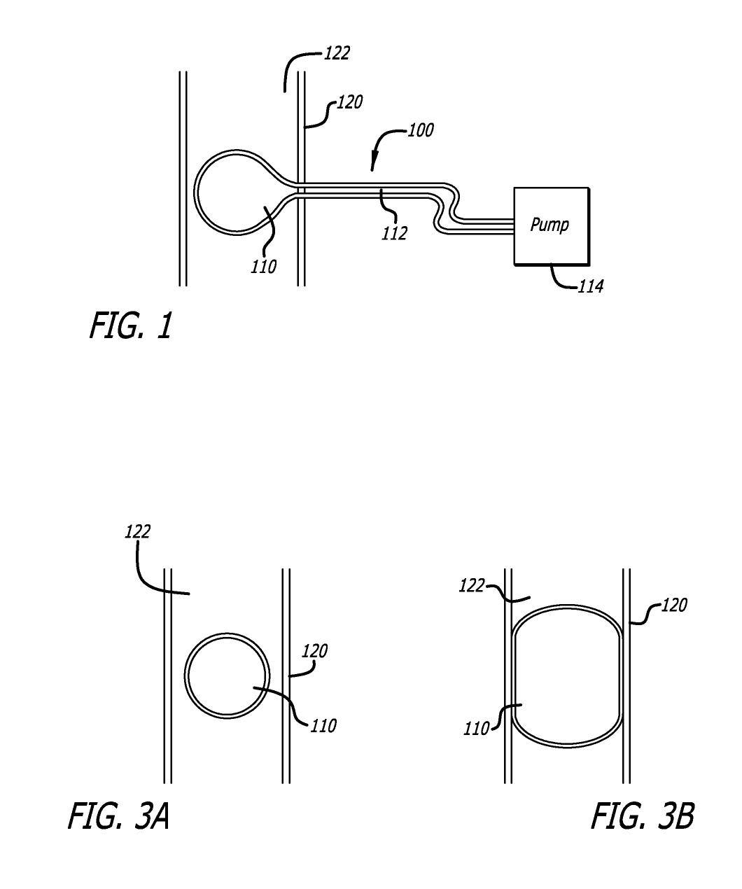

According to embodiments of the present disclosure and as shown in FIG. 1, clamp system 100 is shown. Clamp system 100 comprises, according to embodiments, expandable member 110 which is disposed substantially within vessel lumen 122 of vessel for transporting fluid 120. Expandable member 110 is connected to pressure controller 114 via conduit 112.

According to embodiments, vessel for transporting fluid 120 comprises piping or tubing. For example and according to embodiments, vessel for transporting fluid 120 may comprise surgical tubing used to deliver to patients pharmacological agents and other similar excipients.

Expandable member 110 is a compliant material, such as a balloon. When a gaseous or liquid substance is added to or removed from expandable member 110, expandable member 110 increases or decreases in volume, respectively due to pressure changes. Expandable member 110 may be made from silicon, urethane, polyisoprene, or rubbers, for example.

According to embodiments, expandable member 110 is substantially enclosed within lumen 122 of vessel for delivering fluid 120, except where pressure controller 112 connects with expandable member 110. The interior of expandable member 110, conduit 112, and pressure controller 114 are in fluid or gaseous communication. Conduit 112 comprises tubing, piping, or other similar devices that allow pressurized gas or fluid to be transferred from pressure controller 112 to expandable member 110. According to embodiments, conduit 112 is pressurizable tubing. Artisans will readily appreciate that the choice of material for conduit 112 may be nearly any device that facilitates the movement of pressurized gas or liquid.

Conduit 112 crosses through the wall(s) of vessel for transporting fluid 120 and connects to expandable member 110. Vessel for transporting fluid 120 is sealed at the point where pump conduit 112 crosses through the wall(s) to prevent the fluid being delivered through vessel for transporting fluid 120 from leaking out of vessel for transporting fluid 120, according to embodiments. A sealant, for example silicon or other biocompatible sealants known to artisans, may be applied to seal the wall(s) of vessel for delivering fluid 120 against leakage at the point where conduit 112 crosses.

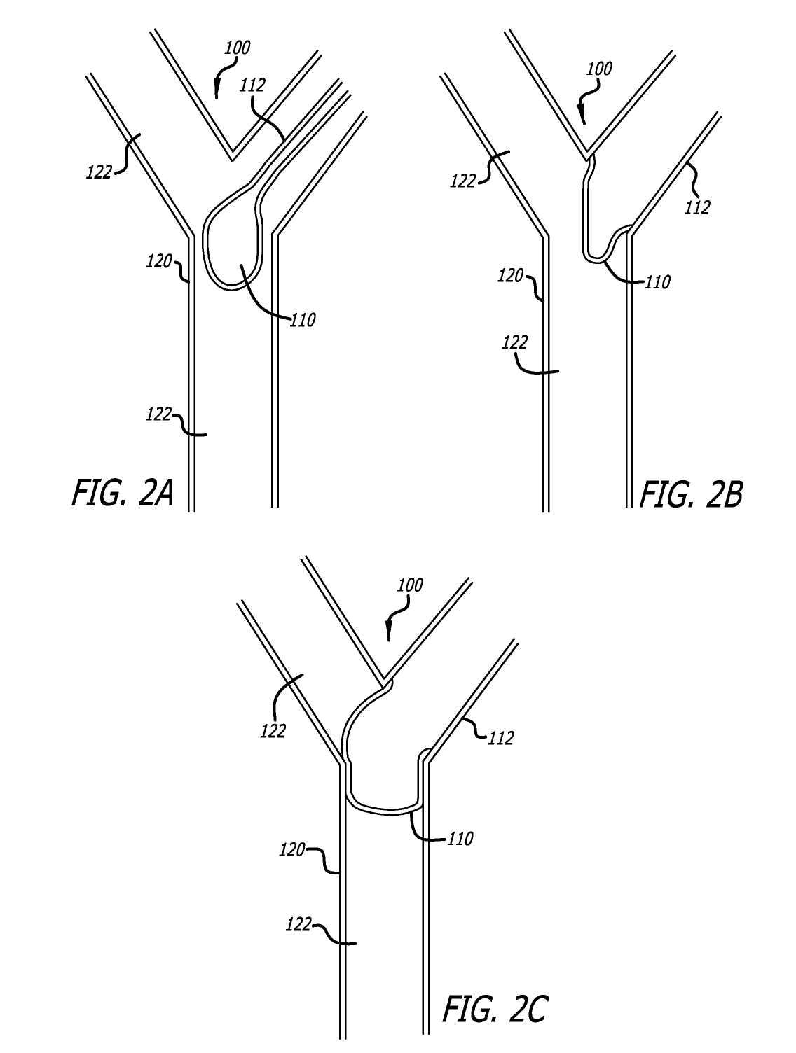

According to embodiments, and as illustrated in FIG. 2A, a ‘Y’ valve may be used instead of causing conduit 112 to pass through the wall of vessel for transporting fluid 120, whereby expandable member 110 is introduced at the junction of the ‘Y’ and conduit 112 is disposed in one of the “arms” of the ‘Y.’ For example, as illustrated in FIG. 2A, expandable member 110 and conduit 112 are inserted through one of the arms of the ‘Y.’ Through the other arm of the ‘Y’ and through the stem of the ‘Y’ the fluid flows through vessel for transporting fluid 120.

According to variant embodiments and as illustrated in FIG. 2B, expandable member 110 is directly connected to the lumen wall(s) one of the arms of the ‘Y.’ The arm of the ‘Y’ therefore comprises at least a portion of conduit 112 rather than a separate conduit as illustrated in FIG. 2A.

According to embodiments, clamp system 100 provides for a “clamping” action within lumen 112 of vessel for transporting fluid 120 as illustrated generally in FIGS. 2-3. Specifically as illustrated in FIG. 3A, expandable member 110 is in an state whereby fluid being transported through vessel 120 is relatively unimpeded because it occupies a relatively small cross-section of lumen 122. Artisans will appreciate that expandable member 110 may be hooked to a vacuum source, whereby the volume of expandable member 110 is minimized when in a contracted state by reducing the volume as much as possible, thereby allowing a greater volume of fluid to flow by expandable member 110 through vessel for transporting fluid 120.

When the flow rate of the fluid flowing through vessel for transporting fluid 120 is too great, the flow rate may be reduced by increasing the volume of expandable member 110. As the volume of expandable member 110 increases, the flow rate of the fluid being transported through vessel for transporting fluid 120 decreases as expandable member 110 occupies an increasing percentage of the cross-sectional area of lumen 122. According to embodiments, flow may be completely impeded by expanding the volume of expandable member 110 to occupy 100% of the cross-sectional area of lumen 122, as illustrated in FIG. 3B.

Likewise, as pressure controller 114 increases pressure within expandable member 110 of FIG. 2C, expandable member 110 expands. Expandable member 110, according to embodiments, is able to occupy relatively little of the cross-sectional diameter of lumen 122 as illustrated in FIG. 2B or occupy up to the entire cross-sectional diameter of lumen 122 and arrest flow of fluid through vessel for transporting fluid 120 completely, as illustrated in FIG. 2C.

According to embodiments, pressure controller 114 comprises a pump/valve system. The pump increases pressure in expandable member 110. A valve system or second pump is used to decrease the pressure in expandable member 110. Valve systems may have incorporated into them flow restrictors to better regulate the amount of pressure removed from expandable member 110.

According to embodiments, pressure controller 114 comprises a lead screw system. As the screw turns pressure is increased or decreased in expandable member 110, depending on the direction the screw turns, thereby increasing the volume or decreasing the volume of expandable member 110, respectively. Lead screws and their application as a pressure controlling mechanism are well known to artisans.

Likewise according to embodiments, pressure controller 114 comprises pressurized reserves of gas or fluid together with a valve system. When expandable member 110 needs expansion, a valve is opened between expandable member 110 and a pressurize reservoir, causing expandable member 110 to expand as pressure increases. When expandable member 110 needs to contract, a valve is opened to the ambient environment, allowing pressure in expandable member 110 to decrease, thereby reducing the volume of expandable member 110.

According to embodiments, the clamps of the present disclosure comprise expandable member 110 disposed outside of vessel for transporting fluid 120. Accordingly, expandable member 110 comprises a collar-like apparatus around vessel for transporting fluid 120, which operates by reducing cross-sectional area of vessel for transporting fluid 120 for the exterior. According to these embodiments, flow is controlled by reducing the cross-sectional flow area by the wall of lumen 122—as flow is reduced expandable member 110 is increased in volume, which presses against the wall of lumen 122 thereby “squeezing” the wall in towards the center of lumen 122 and reducing the cross-sectional flow area. Advantageously, disposing expandable member 110 outside of vessel for transporting fluid 120 prevents gas from entering the flow path in the event of a malfunction.

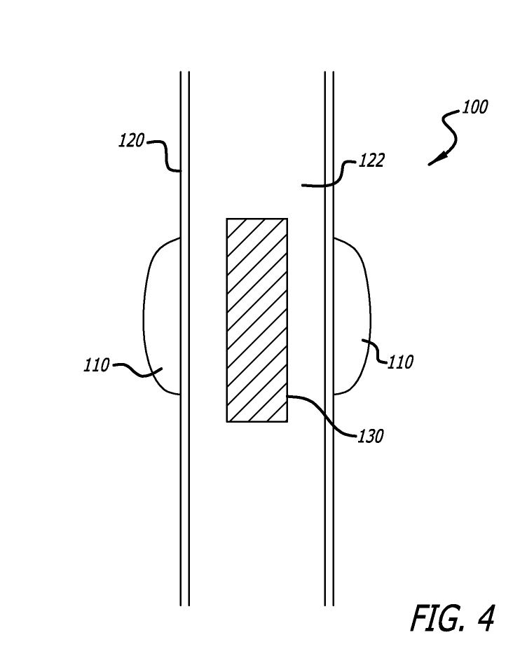

According to similar embodiments and as illustrated in FIG. 4, within lumen 122 of vessel for transporting fluid 100 is block 130. Block 130 comprises a member that expandable member 110 may constrict against when expanded to prevent flow of fluid through vessel for transporting fluid 120. Block 130 may comprise a bearing or other solid implements within vessel for transporting fluid 120 that is able to remain substantially stationary within vessel for transporting fluid 100 and allow flow of fluid around it.

According to the embodiment illustrated in FIG. 4, as expandable member 110 expands, the cross-sectional diameter of vessel for transporting fluid 120 is reduced as it is constricted by expandable member 110, thereby reducing flow through vessel for transporting fluid 120. According to embodiments, expandable member 110 comprises rigid components as well as the compliant expandable components. The rigid components may serve as the external portions of expandable member 110 and the compliant components are disposed against the outer wall of vessel for transporting fluid 120. Thus, when the pressure of expandable member 110 increases, expansion of the expandable member 110 occurs only at the wall of vessel for transporting fluid 120, thereby effecting changes to the cross-sectional diameter of vessel for transporting fluid 120 at the site of expandable member 110. Thus, flow rate of the fluid flowing through vessel for transporting fluid 120 is modulated. According to embodiments, as expandable member 110 further expands, it eventually causes the walls of vessel for transporting fluid 100 to press against block 130, thereby cutting off or substantially cutting off flow of the fluid through vessel for transporting fluid 120.

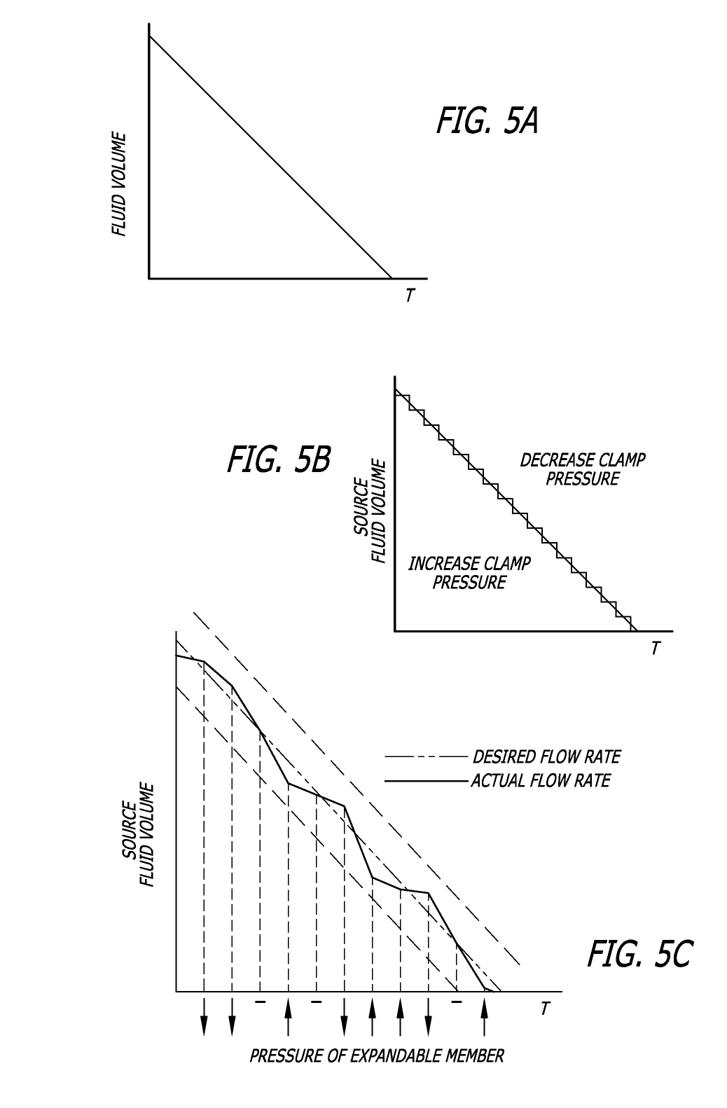

As illustrated in FIGS. 5A and 5B, the clamp devices of the present disclosure provide a platform to ensure relatively constant flow rate from a fluid source. According to embodiments and as shown in FIG. 5A, a theoretical fluid delivery is illustrated.

The devices of the present disclosure allow for relatively constant flow rate by adjusting the volume of the expandable member to either increase or decrease flow rate, as needed to compensate for inherently variable flow rates due to operation or design of pumps, head-heights, or theoretical flow models having variable flow rates, for example or as illustrated in FIG. 5B. By observing flow rate in real time or about real time, a determination is made as to whether the flow rate is occurring as desired, in which no change to the clamps would be made; flow rate is too slow, in which the balloon clamp would be adjusted to a less expanded state; or flow rate is too fast, in which the balloon claim would be adjusted to a more expanded state. The result of adjusting pressure within the balloon and therefore volume of the balloon is an increase or decrease in the cross-sectional area through which flow occurs.

The devices of the present disclosure are able to substantially approximate nearly any desired flow curve or model, including the linear model illustrated in FIG. 5A. Thus, the devices of the present disclosure are useful for nearly any application whereby flow rate varies over time.

According to embodiments, an apparatus, such as a microprocessor may be used to monitor the flow rate and automatically change the volume of the expandable member to adjust the flow rate to model the theoretical flow rate of FIG. 5A. According to embodiments, such adjustments are shown in FIG. 5B. According to FIG. 5B, flow rate assume a step-wise type flow. The “steps” in FIG. 5B represent changes in the flow rate of the fluid flowing through the vessel for transporting fluid 112 due to adjustments in the volume of the expandable member 110 depending on whether the observed flow rate is too fast or too slow. If too fast, the volume of the expandable member is increased and if too slow, the volume of the expandable member is decreased. Because the flow rate from the pump source may fluctuate or be non-linear over time, adjustments are made throughout the flow process to achieve a desired degree of flow accuracy. As shown in FIG. 5B, artisans will readily appreciate that the steps as shown are much larger than is likely in actual practice to illustrate the principle. Moreover, the horizontal and vertical slopes are only exemplary to clearly show in the illustration how step-wise changes can approximate a desired flow curve and is not intended to be limited in any way.

Indeed, FIG. 5C is exemplary of the use of the clamps and feedback mechanisms of the present disclosure to more closely mimic a desired flow curve. As illustrated in FIG. 5C, a desired flow rate is illustrated by the broken line. The actual flow rate is shown with a solid line. The dashed lines between the x-axis and the actual flow rate line each represent a period of time. Initially, the actual flow rate was too slow as not enough volume of source fluid is delivered during the first interval as desired. Consequently, the volume of expandable member 110 was reduced, which increased the cross-sectional area of vessel for transporting fluid 120 allowing more fluid to pass expandable member 110 per unit time.

Over the second time interval, flow rate closely mirrored the desired flow rate (the slope of the desired and actual flow rates are the same), but the total volume of fluid delivered continued to lag the desired amount of fluid delivered at the end of time interval two (because the actual flow rate line is above the desired flow rate line at the end of time interval two). Thus, the volume of expandable member 110 was again reduced to increase flow rate and move the overall volume delivered towards the desired volume to be delivered.

At the end of time interval three, the total volume delivered was the same as the desired total flow volume delivered. It will also be observed, however, that the actual flow rate is greater than the desired flow rate. According to the exemplary embodiment, the measurement of total volume was determinative of whether the volume of expandable member 110 was varied. Thus, according to the exemplary embodiment, no adjustment to expandable member 110 was made at the end of time interval three. Artisans will readily appreciate that flow rate over time interval three or any other arbitrary interval may be used instead of total volume delivered at the end of any time interval to determine adjustments to expandable member 110.

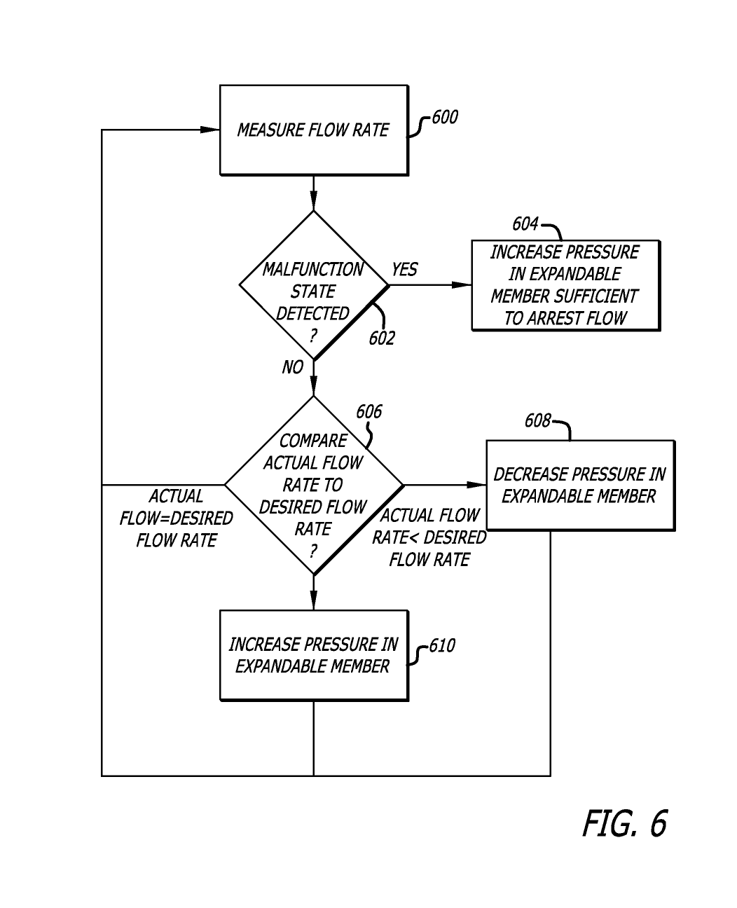

Because no adjustment was made to expandable member 110 at the end of time interval three, the flow rate remained the same throughout time interval four. Thus, at the end of time interval four, the total volume delivered was greater than desired due to the more rapid than desired flow rate. Thus, the volume of expandable member 110 was increased to reduce the cross-sectional area of vessel for transporting fluid thereby reducing the flow rate. At each time interval, the flow volume was measured and the volume of expandable member 110 was adjusted accordingly to more closely follow the desired flow volume of time. According to embodiments, depending on the difference between the desired flow rate and the actual flow rate, the amount by which the volume of expandable member 110 is adjusted is variable, thereby allowing the system and method to more rapidly approximate the desired flow at the end of the next time interval. Likewise, if enough computing power is present, a database of flow values may be used to both store and lookup the correct adjustment at any time interval based on the flow rate from the prior time periods; similarly, mathematical algorithms may accomplish the same objective. When the time intervals are small enough, over long periods of time, the desired flow rate is closely approximated by using expandable members 110 of the present disclosure. The principles of closely approximating a theoretical flow rate is more clearly understood in combination with the methods illustrated in FIG. 6.

FIG. 6 is a flow chart of embodiments of methods of the present disclosure whereby the clamps disclosed herein are utilized together with a pump system having the ability to measure flow rate in real time or about real time. The methods disclosed herein may be automated with a simple microprocessor. In operation 600, flow rate is measured. The measurement of flow rate may occur in real time or about real time in cases where the fluid cannot be contacted directly to measure flow. For example, the pumps that do not contact the fluid are described in U.S. Pat. No. 7,008,403, the teachings of which are hereby incorporated by reference.

According to embodiments, a determination is made as to whether a malfunction state exists. A malfunction state may be, for example, detected if the flow rate is determined to be outside of a range of permissible flow volumes or if the a pump malfunctions thereby causing unpredictable flow of the fluid through vessel for transporting fluid. In drug delivery scenarios, errors occur where unexpected flow of therapeutic agents is a considerable safety concern. For example, the administration of insulin is a particularly sensitive process and must be dosed in a relatively narrow range as a matter of safety. If a malfunction state is detected in operation 602, pressure in the expandable member 110 is immediately increased to arrest flow or minimize flow of the fluid flowing through vessel for transporting fluid 120 in operation 604.

However, if a malfunction state is not detected, the flow rate is compared to a desired flow rate in operation 606. If the flow rate as measured in operation 600 is the same as the desired flow rate at a given time interval (actual flow=desired flow rate) no adjustments are made to expandable member 110 and the flow rate is measured again in the next iteration of the method.

If the flow rate is measured to be less than the desired flow rate at a given time interval in operation 606, (actual flow rate<desired flow rate) then the pressure is decreased in expandable member 110 in operation 608, which causes expandable member 110 to contract. Conversely, if the measured flow rate is greater than the desired flow rate in operation 606, then the pressure in expandable member 110 is increased to expand and thereby slow the flow rate in operation 610. The amount of pressure increase or decrease in expandable member 110 may occur in small increments to slowly expand or contract expandable member 110 over a plurality of iterations of the method, according to embodiments. So doing allows fine tune control over the system and, once the desired flow rate is achieved, the small increments allow for adjustments that closely approximate the theoretical or desired flow rate, as illustrated in FIG. 5C.

According to embodiments, the degree to which expandable member 110 is expanded may be determined using a table of lookup values representing pressure changes for expandable member 110 based on the difference between the actual and theoretical flow rates. Thus, if the flow volume is largely divergent of the desired flow volume, the expandable member 110 is expanded by a larger increment, which allows expandable member 110 to arrive at a level of expansion causing the desired flow rate more rapidly.

According to other embodiments, expandable member 110 may be designed to have a small plurality of predetermined expansion states. Although these expansion states may not be capable of exactly effecting the desired flow rate, the system will expand and contract expandable member 110 rapidly over time based on the real time flow feedback to deliver the fluid on average commensurate with the desired flow rate. Thus, according to these embodiments, by expanding and contracting expandable member 110 rapidly, the desired flow rate is approximated, for example as shown by the graph in FIGS. 5B and 5C.

As illustrated in FIG. 5C, as the actual flow rate (solid line) is compared to the theoretical flow rate (dashed-solid line) at time intervals shown by the vertical dotted lines (operation 606 of FIG. 6), the actual flow rate is observed to be greater than the theoretical flow rate (for example, time interval 1), equal to the theoretical flow rate (for example, time interval 3), or less than the theoretical flow rate (for example, time interval 4).

Correspondingly, along the x-axis there is shown the action taken based on the comparison of operation 606. Where there exists a dash (-), the actual flow rate is determined to be approximately the same as the desired flow rate and no adjustment is made to the volume of expandable member 110. In cases with an down arrow (↓), the actual flow rate is too slow compared to the desired flow rate and pressure in expandable member 110 is decreased in operation 610 to increase the actual flow rate. Similarly, in the cases having a up arrow (↑), the actual flow rate is too rapid compared to the desired flow rate and pressure in expandable member 110 is therefore increased in operation 608 to decrease the actual flow rate.

According to embodiments, the microprocessor compares actual volumes delivered over time rather than flow rate, which requires greater processing time and power. At certain time intervals where it is determined the actual flow volume equals the theoretical flow volume, the actual flow rate is in fact different from the theoretical flow rate at these points (see around time interval 2) as illustrated by the different slopes of volume over time. However, according to embodiments, the microprocessor only calculates volumes or calculates flow rate from time zero to the chosen interval (e.g., time interval 2 where the flow rate over the entire time is equal in both the theoretical and actual instances because the same volume has been delivered over the same time interval) and is unable to perceive whether the flow rate is too fast or two slow. Therefore, the system “waits” until the next iteration where the actual flow volume is observed to be different from the theoretical flow volume to make an adjustment. According to the graph, in time interval 3, this change is finally observed and the pressure in expandable member 110 is decreased as the actual rate was too slow through time interval 2.

According to other embodiments, the microprocessor calculates and compares flow rates. Accordingly, expandable member 110 is only unadjusted when the both instantaneous flow rate and the total flow volume equal the desired flow rate and total flow volume at a given interval, respectively. Otherwise, adjustments to expandable member 110 are made. For example, at a given time interval, microprocessor may determine that the flow rate (slope in the graphs of FIG. 5) is equal to the desired flow rate at the given time interval. However, due to previous pump variations and corrections in expandable member, the total volume delivered from the start through that time interval is less than the volume theoretically delivered. Thus, at the given time interval, although the flow rate models the desired flow rate, the flow rate will be increased by adjusting expandable member to make up for the difference between the actual volume delivered and the desired volume to be delivered at that time interval. Similarly, the actual volume delivered may equal the desired flow volume delivered at a given time interval but the flow rate will not equal the desired flow rate (i.e., in the next time interval, both the flow rate and the total volume delivered will be divergent from the desired values unless and adjustment is made to expandable member 110). In both cases, adjustments must be made to expandable member 110 to approximate the desired flow over time.

According to embodiments, microprocessor may also be configured to determine whether flow is outside a predetermined set of tolerances. For example, as illustrated in FIG. 5C, flow must remain within the dashed tolerance lines shown parallel to the desired flow rate line. If flow is detected to be outside of these tolerances, microprocessor immediately increases the volume of expandable member to arrest flow.

While the apparatus and method have been described in terms of what are presently considered to be the best mode, it is to be understood that the disclosure need not be limited to the disclosed embodiments. It is intended to cover various modifications and similar arrangements included within the spirit and scope of the claims and the principles disclosed herein, the scope of which should be accorded the broadest interpretation so as to encompass all such modifications and similar structures. The present disclosure includes any and all embodiments of the following claims.

1. A device comprising:
a vessel for transporting a fluid;
an expandable member disposed with the vessel for transporting the fluid;
a pressure controller for modulating the pressure within the expandable member; and
a microprocessor for calculating a calculated flow rate;
wherein the pressure in the pressure in the expandable member is modulated to control the flow rate of the fluid through the vessel;
wherein the modulation is determined at least based on data provided from the calculated flow rate.

2. The device of claim 1, wherein the expandable member is disposed within the vessel for transporting fluid.

3. The device of claim 1, wherein the expandable member is disposed outside the vessel for transporting fluid.

4. The device of claim 3, wherein a block is disposed within the vessel for transporting fluid whereby when the expandable member is fully expanded, the walls of the vessel for transporting fluid contact the block to substantially prevent the flow of fluid.

5. The device of claim 1, wherein the pressure controller comprises a pump and valve system.

6. The device of claim 1, wherein the pressure controller comprises a lead screw.

7. The device of claim 1, wherein the pressure controller comprises a pressurized reservoir and relief valve.

8. The device of claim 1, wherein the expandable member may be expanded to prevent flow through the vessel.

9. A method comprising providing:
a vessel for transporting a fluid;
an expandable member disposed with the vessel for transporting the fluid;
a pressure controller for modulating the pressure within the expandable member; and
a microprocessor for calculating a flow rate of the fluid;
wherein the pressure in the expandable member is modulated to control the flow rate of the fluid through the vessel;
wherein the modulation is determined at least based on data provided from the calculated flow rate.

10. The device of claim 9, wherein the expandable member is disposed within the vessel for transporting fluid.

11. The device of claim 9, wherein the expandable member is disposed outside the vessel for transporting fluid.

12. The device of claim 11, wherein a block is disposed within the vessel for transporting fluid whereby when the expandable member is fully expanded, the walls of the vessel for transporting fluid contact the block to substantially prevent the flow of fluid.

13. The device of claim 9, wherein the pressure controller comprises a pump and valve system.

14. The device of claim 9, wherein the pressure controller comprises a lead screw.

15. The device of claim 9, wherein the pressure controller comprises a pressurized reservoir and relief valve.

16. The device of claim 9, wherein the expandable member may be expanded to prevent flow through the vessel.

17. A method comprising:
measuring the flow rate of a fluid within a vessel for transporting the fluid in about real time; and
modulating the expansion of an expandable member disposed with the vessel for transporting the fluid to change to flow rate of the fluid through the vessel based at least in part on the measured flow rate.

18. The method of claim 17, further comprising using the measured flow rate to determine how much modulation of the expansion of the expandable member to effect.

19. The method of claim 17, wherein the volume of the expandable member is modulated with at least one of a pump or a valve, wherein the pump is used to increase the volume of the expandable member and the valve is used to decrease the volume of the expandable member.

20. The method of claim 17, wherein the volume of the expandable member is modulated using a lead screw.

21. The method of claim 17, wherein the pressure controller comprises a pressurized reservoir and relief valve.
